(19) United States
(12) Patent Application Publication
(10) Pub. No.: US 2011/0029520 A1
(43) Pub. Date: Feb. 3, 2011

(54) DATA CURATION

(75) Inventors: Stephen John Leary, South Gloucestershire (GB); Richard Charles Mant, Gloucestershire (GB)

Correspondence Address: BUCHANAN, INGERSOLL & ROONEY PC, POST OFFICE BOX 1404, ALEXANDRIA, VA, 22313-1404, US

(73) Assignee: BAE Systems plc, London (GB)

(21) Appl. No.: 12/439,067

(22) PCT Filed: Dec. 17, 2008
(86) PCT No.: PCT/GB2008/051194

§ 371 Date: Feb. 26, 2009

(30) Foreign Application Priority Data
Dec. 18, 2007 (EP) 07270073.5
Dec. 18, 2007 (GB) 0724545.9

(51) Int. Cl. G06F 17/30

(52) U.S. Cl. 707/737; 707/E17.046

(57) ABSTRACT

A method of data curation and a data processing apparatus for performing the method are provided. The method comprises the steps of (i) identifying a first set of variables which represent predetermined characteristics of data stored in one or more of a number of data packages; (ii) identifying a second set of variables which represent different possible states of each said number of data packages; (iii) identifying a functional relationship between the first and second sets of variables so as to provide a functional representation based on said sets of variables; (iv) allocating different states to the data associated with each said number of data packages according to an iterative procedure, wherein the iterative procedure comprises iteratively calculating values of said variables and of the functional representation until the values satisfy predetermined convergence criteria, and the allocation of a state to one or more of the data packages is effected in dependence upon a comparison of the calculated values of said variables and of the functional representation; and (v) performing an action on the data associated with each said number of data packages corresponding to the allocation of states in step (iv).

This invention concerns improvements relating to data curation, in particular in relation to computer generated data files containing simulation/numerical data.

As technology progresses, many design processes increasingly use simulation techniques in place of, or to support, conventional prototyping activity. During the design cycle of any complex vehicle (e.g. an aircraft) many thousands of computational simulations are performed to analyse fluid flow over the vehicle, structural loading on the vehicle and thermal characteristics through the materials of the vehicle, to name but a few. Each of these simulations produces a number of results data files. Each data file may contain a few GB of data or may contain more than 100 GB of data.

In addition, testing techniques, such as wind tunnel testing, are becoming more sophisticated so that the results of a small scale simulation can be scaled in a reliable manner. The increased sophistication generally leads to a greater number of parameters being stored at a higher frequency and as a consequence testing can also result in enormous data files being produced.

In some instances, key summary data is all that needs to be retained from the results file (e.g. integrated forces acting on a body). However, in other cases it may be necessary to keep the entire raw data set to enable the data to be interrogated several months after the simulation has been performed. This subsequent interrogation may be required in order to validate additional simulations or to extract further data that was not deemed pertinent at the time of performing the initial simulation.

Although the costs associated with hardware storage are reducing, the volume of data involved results in significant expense. Manipulation and retrieval of relevant information can be difficult when storage of the data is indiscriminate and perhaps excessive.

When not all data is stored and some selection of the data to be retained is undertaken, this selection is typically governed by the global data retention policies in place within an organisation. Such policies generally have blanket coverage and can therefore be inappropriate for any one particular type of data. For example, some commercial airframe manufacturers retain all simulated data while others discard all data not accessed in some way for a period of time (e.g. three months).

In the former case, enormous quantities of data may be retained making retrieval of any particular file rather onerous. In the latter scenario, the majority, if not all, data is deleted and any subsequently required data must be regenerated either from scratch or from retained set-up data files irrespective of the complexity of the data. Successful regeneration of data is also highly dependent upon comprehensive version control of the software used to generate the data in the first place. In particular if the software used to generate the data has been modified, subsequent results may vary from the initial results and it may be difficult to determine why such differences arose.

According to a first aspect, the invention provides a method of data curation comprising the steps of: (i) identifying a first set of variables which represent predetermined characteristics of data stored in one or more of a number of data packages; (ii) identifying a second set of variables which represent different possible states of each said number of data packages; (iii) identifying a functional relationship between the first and second sets of variables so as to provide a functional representation based on said sets of variables; (iv) allocating different states to the data associated with each said number of data packages according to an iterative procedure, wherein the iterative procedure comprises iteratively calculating values of said variables and of the functional representation until the values satisfy predetermined convergence criteria, and the allocation of a state to one or more of the data packages is effected in dependence upon a comparison of the calculated values of said variables and of the functional representation; and (v) performing an action on the data associated with each said number of data packages corresponding to the allocation of states in step (iv).

In this specification, the term “data curation” is used broadly to mean the process of archiving the most relevant elements of generated data (i.e. those that are likely to be useful in future), retaining these elements on appropriate hardware and addressing aspects such as backups, redundancy, indexing and journaling of the data.

In this specification (as will be described hereinafter), the term “optimisation” is used to mean an iterative calculation procedure in the sense that it starts with an initial set of states, applies computation to that set of states, compares the result with the initial result, uses the result of the comparison to modify the initial set and then repeats iteratively the steps until a predetermined level of accuracy is achieved. The terms “optimiser”, “optimal”, “optimised” and “optimal solution” as used in the specification are to be understood in this context.

In this specification, the term “data package” is used broadly to cover a single data file as well as many arrays of data and collections of data files.

Advantageously, by configuring the controller so that data curation is carried out by comparing local characteristics (variables) associated with each data package to user defined constraints/objectives, it becomes possible to determine automatically which data packages are to be retained within a data store. Consequently, a relevant set of data that can be readily accessed can be effectively maintained.

Preferably, the method comprises processing one or more of the data packages on rewritable storage where a first state allocated to the data is an intention to delete the data package(s) from the storage while taking no further action and a second state allocated to the data is an intention to retain the data package(s) on the storage.

Optionally, another state allocated to the data is an intention to create a copy of said one or more data packages on different storage.

Optionally, another state allocated to the data is an intention to create a compressed version of said one or more data packages on the same or different storage.

Conveniently, the convergence criteria used in the iterative procedure are applied by calculating a change in the value of the functional representation between two or more successive iterations of values of the representation and determining whether the calculated change in the value of the representation is substantially equal to a specified tolerance.

Optionally, the functional representation is of the vector form: F=f (t, cₛ), F being defined as a function of (i) the original time t taken to generate the data, and (ii) the cost cₛ of the software required to regenerate the data.

Optionally, the functional representation is of the vector form: F: f (t, cₛ, d_{ct}, dᵢₐ, dₕₘ, dᵢ, dₛ), F being defined as a function of (i) the original time t taken to generate the data, (ii) the cost cₛ of the software required to regenerate the data, (iii) when the data d_{ct} was created, (iv) when the data dᵢₐ was last accessed, (v) how many times the data dₕₘ has been accessed, (vi) the importance of the data dᵢ and (vii) the size of the data dₛ. According to embodiments of the invention, one or more or a combination of these elements of the function can be suitably minimised (or maximised as appropriate) as would be understood by the person skilled in the art, whilst being subject to other constraints.

The second set of variables may correspond to a set of independent variables, and the first set of variables may correspond to a set of dependent variables which are dependent on the second set of variables.

Optionally, the method may include summing the values of the first set of variables which represent different characteristics of the data stored in said one or more data package(s) and selecting the data according to the sum values on which action is to be performed.

Optionally, the method may further comprise: (a) a first step of selectively presenting the data to a user; (b) a second step of requesting authorisation from the user to perform an action on the data; and (c) a third step of performing the action only subject to grant of the authorisation request.

Optionally, the method may further include a step of repeating the above described steps (i) to (iv) in a series of time steps as an iterative procedure such as to enable a recalculation of the values of the variables, in the event that the authorisation request is refused.

Conveniently, the data packages are digital data packages. The digital data packages may be binary data packages.

Further, this invention resides in a computer program comprising program code means for performing the method steps described hereinabove when the program is run on a computer.

Further, this invention resides in a computer program product comprising program code means stored on a computer readable medium for performing the method steps described hereinabove when the program is run on a computer.

As will be described hereinafter, the above described (algorithmic) steps can be effectively implemented on data processing apparatus.

The above and further features of the invention are set forth in the appended claims and will be explained in the following by reference to various exemplary embodiments which are illustrated in the accompanying drawings in which:

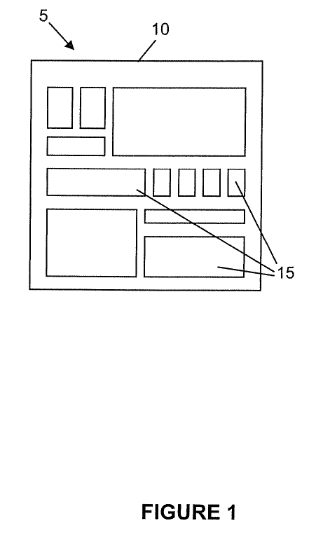

FIG. 1 is a schematic representation of a data storage medium;

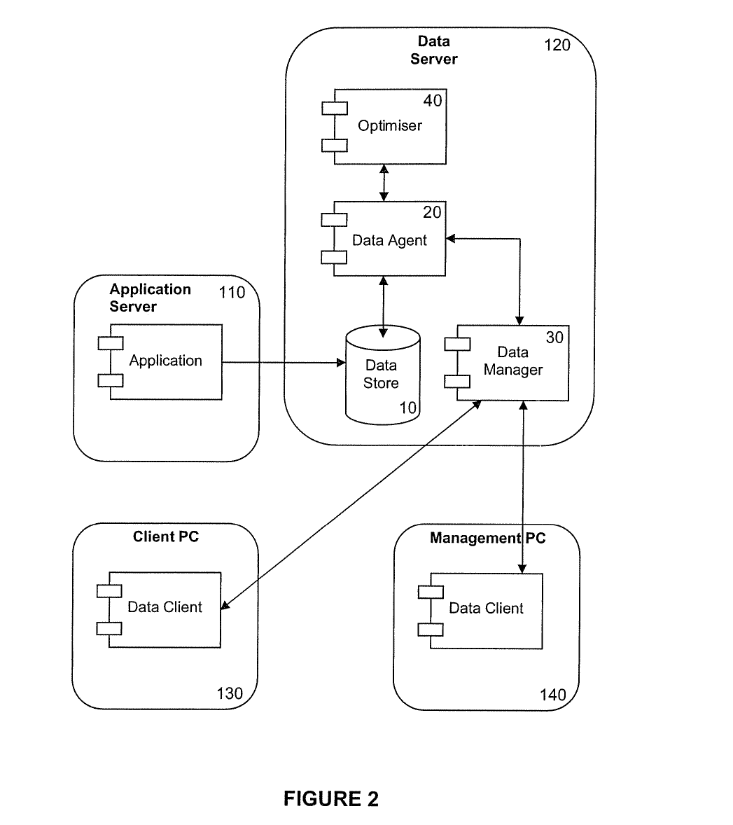

FIG. 2 is a schematic representation of a computer system for performing a method of data curation embodying the invention;

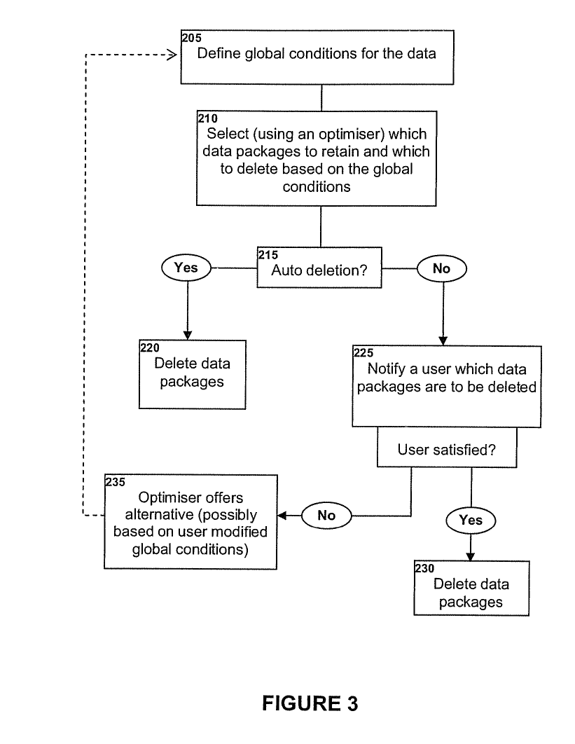

FIG. 3 is a flow diagram representing a method of data curation embodying the invention;

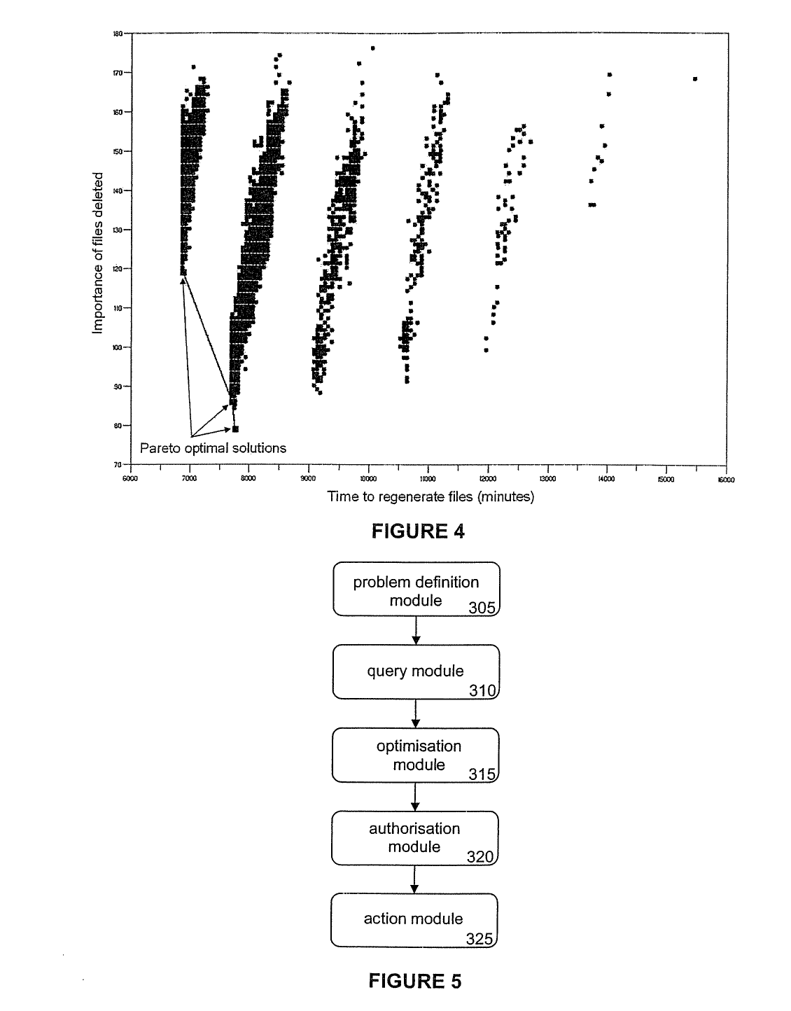

FIG. 4 is a graph showing an example of data selection; and

FIG. 5 is a flow diagram illustrating modules of the method of FIG. 3.

In describing embodiments in accordance with this invention (as will be described hereinafter), it is to be understood that there are dependent variables (“local”) which are associated with a single data file (e.g. single data file size) and that there are other dependent variables (“global”) which are associated with cumulative file size (e.g. total file size obtained by summing the “local” variables). Further, as will be described hereinafter, it is to be understood that there are independent variables in the invention which are associated with status of the data files/data packages (for example, “retain”/“delete”/“compress”).

Data 5 stored in the data store 10 illustrated in FIG. 1 comprises a number of files or data packages 15. These data packages may be stored all in a single directory or, alternatively, may have a data structure associated with the data store 10. The data packages are digital (e.g. binary) data packages. The data structure may comprise a number of directories, sub-directories and even different domains. Each of these directories and domains of the data store 10 may be physically co-located on the same hardware or they may be distributed across a number of storage devices. Whilst the costs associated with hardware storage devices are reducing, storage of significant quantities of data 5 lead to escalating costs. Furthermore, inefficient storage of data leads to inefficient retrieval of any particular data package 15 and so it is desirable to improve the management of the storage of data 5. This management of the data 5, hereinafter referred to as data curation, may be directed towards a single sub-directory, or it may be directed at an entire data store 10, or it may be directed at one or more domains each being resident on a different data store 10.

FIG. 2 illustrates a computer system comprising a data store 10 having a method of data curation embodying the invention implemented thereon. The computer system comprises an application server 110 upon which are installed one or more software applications, for example numerical modelling software applications. Each application is used to generate results files or data packages 15 which are subsequently stored in data store 10. As illustrated, the data store 10 resides within a data server 120. The data server 120 also comprises a data agent 20 for monitoring and managing the data 5 stored in data store 10 and a data manager 30. Data agent 20 receives instructions from the data manager 30 which, in turn, sends information to and receives information from clients 130 and management 140.

Generally, many clients write data 5 or run applications that write data 5 to data store 10 and so data packages 15 of many different types and from many different sources accumulate on data store 10. System constraints are defined by the management 140 to reflect the capacity, requirements and objectives for the computer system. Data agent 20 constantly monitors data 5 within data store 10 to see if any of the system constraints are approaching their limits which may indicate that a potential data storage problem is impending. Data curation can be performed if such a violation becomes imminent, or if a predetermined interval has elapsed, or upon manual instruction from the management 140.

The data server 120 comprises an optimiser 40 which may be invoked by data agent 20 to find one or more optimal solutions to the potential data storage problem. The optimiser 40 uses “global” variables (conditions) defined by management 140 together with “local” variables associated with each data package to generate the, or each, optimised solution. Further detail on the “global” variables (conditions) and “local” variables is given below. The, or each, optimal solution is passed to the data manager 30 by the data agent 20. The data manager 30 then presents the, or each, optimal solution to the management 140 for selection or authorisation. If a single solution is presented, management 140 may disagree with the proposed optimal solution and modify the “global” variables (conditions) upon which the “optimisation” was carried out.

Clients 130 may also be informed of the potential optimised solution, especially if this solution would impact a client's files. If a client 130 disagrees with the proposed solution the data manager 30 can be informed, the client 130 can modify “local” variables associated with their own data and the data manager 30 may instruct the data agent 20 to reinvoke the optimiser 40 to generate further optimised solutions. Once an optimal solution has been selected and agreed/authorised by all relevant parties, the solution can be implemented and the actions proposed thereby carried out. Data packages 15 are archived, deleted, retained or compressed as required to achieve the proposed solution.

Each data package 15 may contain different types of information. Many data packages 15 contain results from computational or physical simulations or analysis performed to assess characteristics of a proposed design. For example, the simulations may be one or more of the group of structural mechanics analysis, fluid dynamics analysis, thermal analysis and electromagnetic analysis. Alternatively, the data packages 15 may relate to non-simulation data. A data package 15 may be very large, containing raw data involving many arrays of data, another data package 15 may contain summary data, in which case the size of the data package may be quite small.

Different types of data package 15 merit different retention rules. Each data package 15 can effectively be assessed in relation to various criteria in order to determine whether to retain the data package 15 in its entirety or whether to delete the data package 15.

In deciding to delete a particular data package 15, consideration must be given to the likelihood of the content of the data package 15 being required at a later date. If the content of the data package 15 may be subsequently required, the burden of regenerating the deleted data can be assessed to determine whether this burden can be borne or whether it is more efficient to retain the original data package. Variables associated with regenerating the deleted data include the time taken to regenerate the data package and the costs associated with regeneration of the data package.

In deciding to retain a particular data package 15, consideration must be given to the storage requirements of the data package, for example the size of the data package.

Other criteria which may govern the decision to retain or delete the data package include the relevance of the information stored in the data package. For example, how often is the data package accessed, when was the data package last accessed and when was the data package created.

Each of these criteria or “local” variables may be used to score effectively the merits of retaining or deleting each particular data package. This score can then be used “globally” to assess a given combination of data packages each having a proposed “delete” or “retain” action associated therewith.

In summary, the “local” variables include, but are not restricted to the following:—

1. the size of the data package

2. the time it took to generate the data package

3. when the data package was created

4. when the data package was last accessed

5. how many times the data package has been accessed

6. the importance of the data package

7. economic cost to generate the data package

Some of these “local” variables are readily discernable or measurable directly from the data package itself whilst others need to be defined by a user. For example, the “importance of the data package” could be based on aspects such as whether the information contained within the data package 15 (say results of a simulation) actually relate to a final product or whether the particular information contained within the data package has been superseded prior to implementation. If simulations were performed by a third party having specialist knowledge to address a particular problem, it would be considered more important to retain any related information. The economic cost of regenerating such data packages is likely to be high and therefore the proposed action associated with the data package should be biased towards “retention” rather than “deletion”. Consequently, the data package is likely to be given a high “importance” rating to deter deletion thereof.

These “local” variables can readily form the basis for defining a number of “global” variables (conditions) by which a number of data packages, collectively referred to as a data set, can be assessed. It may be desirable to minimise or maximise one or a combination of these “local” variables when determining which data package(s) to retain and which data package(s) to delete. For example, an arbitrary function F relating to the impact of regeneration of the information could be defined as a function of the original time t taken to generate the information combined with the cost cₛ of the software required to regenerate the data i.e. F=f(t,cₛ). Thus, in this example, the associated “global” variable (condition) is that the elements t and cₛ of function F are to be minimised for any data packages that are to be deleted.

Alternatively, or in addition to the aforementioned type of condition, an absolute value, constraint or threshold may be assigned to a “global” variable (condition). This threshold value serves as a limit which needs to be either kept above or not exceeded as appropriate. For example, a dedicated storage system may have a particular capacity, say 750 GB, and so a “global” variable (condition) could be defined such that the cumulative magnitude of the data packages to be retained must not exceed this value.

As discussed above, monitoring of the data packages 15 within the data store 10 is performed by a data agent 20 residing on the data server 120 (shown in FIG. 2). The data agent 20 retains address information and status information pertaining to each data package 15 to enable movement or retrieval thereof. Data curation is initiated when the data agent 20 invokes the optimiser 40 to ascertain one or more “optimal solutions”. Each “optimal solution” represents a data set comprising all of the data packages 15 wherein each data package is assigned a particular state. The states relate to a proposed action to be carried out on the data package 15, for example “delete the data package” or “retain the data package”. Other possible states include “compress the data package” and “archive the data package remotely”.

The “optimisation” carried out by the optimiser 40 is based on one or more of the management 140 defined “global” variable (conditions), e.g. minimising above described F function with respect to the data packages to be deleted and/or keeping the overall magnitude of data packages to be retained below a value e.g. 750 GB. In other words, each optimal solution aims to meet as many of the “global” variables (conditions) as possible and each “optimal solution” achieves this to varying degrees of success in relation to each “global” variable (condition).

The “optimisation” may be carried out using any known optimiser that is able to optimise an array of information based on multiple parameters. In one example, a binary “optimisation” procedure is used whereby a data set is defined such that each data package 15 is flagged with one of two particular states, say “retain” and “delete”. The cumulative value of the, or each, relevant “local” variable of that data set is evaluated before a further data set is defined having a different assignment of flags on each data package 15. The data sets are then optimised based on the given “global” variables (conditions) and a number of “optimal solutions” are generated. See below for an illustrated example. If three states were required the corresponding optimiser 40 would use a tertiary “optimisation” procedure, for a greater number of states a correspondingly higher order “optimisation” procedure would be used.

In a second example a multi-level “optimisation” procedure is used whereby in a first instance, the number of data packages 15 to be retained is arbitrarily chosen. Different data sets having this fixed number of data packages 15 to be retained are defined using an intelligent search algorithm to swap the assigned state of data packages within the data set based on the global conditions. A separate “optimisation” is carried out on the number of data packages 15 to be retained. The cumulative value of the, or each, relevant “local” variable of each data set is evaluated by the optimiser to generate one or more “optimal solutions”.

In the above examples, cumulative values of the “local” variables associated with each data package 15 of a given data set are ascertained. However, other operators could be used to evaluate the overall impact of the “local” variable for comparison with the “global” variables (conditions) in order to establish the optimal solutions. If one “local” variable was of particular importance and should weight/bias the results, a multiplication operator could be used rather than a summation operator.

Once one or more “optimal solutions” have been generated, the different “optimal solutions” may be presented to the management 140 by the data manager 30 to select a preferred data set. If the “optimal solutions” presented to the management 140 are not appropriate or desirable, the “global” variables (conditions) defined initially may have been inappropriate and so the management 140 can modify the “global” variables (conditions) or define new “global” variables (conditions). The “optimisation” may then be rerun based on these new or modified “global” variables (conditions) to generate different “optimal solutions”.

Rather than presenting a number of “optimal solutions” from which a preferred solution must be selected, rules relating to selection of a particular solution can be established so that automatic selection can be undertaken. In particular, the “global” variables (conditions) can be given a hierarchy by the management 140 so that dominant variables (conditions) are created. The “optimal solution” biased towards the dominant condition can then automatically be selected as the preferred data set. For example, a high importance factor may outweigh the fact that the file has not been accessed for a long time.

Once a preferred “optimal solution” representing a particular data set has been selected, either manually or automatically, the proposed actions represented by the state of each data package 15 defined by the selected data set can be performed. Data packages 15 having a “compress” state are encrypted and compressed so that the data package requires less space on the data store 10 but the information contained therein remains accessible. Data packages 15 having an “archive” state may be transferred to another storage device which may be less accessible but retains the information contained therein in its entirety. Archiving may include a compressing activity.

Data packages 15 having a “delete” state are completely removed from the data store 10. As discussed above, prior to removal of the data packages 15, authorisation may be acquired from a client, especially where the preferred data set was automatically selected from the “optimal solutions”.

For low risk data, user intervention may not be required prior to removal of the data packages 15. For medium risk data, a notification may be sent to the client 130/management 140 indicating that removal of the data packages 15 will occur in a set period of time unless the client 130/management 140 intervenes and over rules the proposed operation; in this case, management 140 could redefine the “global” variables (conditions) and re-run the “optimisation”, or the hierarchy of the “global” variables (conditions) could be redefined so that another “optimal solution” is selected, or a client 130 could redefine “local” variables associated with their own data packages 15 and request that the “optimisation” is re-run. For high risk data, particular authorisation may be required for each respective data package 15 prior to removal. The level of authorisation required could be defined within additional information associated with the data package 15 itself and retained by the data agent 20—this information is hereinafter referred to as “metadata”.

The “metadata” includes all relevant information required to regenerate each original data package 15. For example, the “metadata” may include references to any input variables or set up files, executable programmes or versions of the software used to generate the data together with details relating to the machine architecture and the operating system version required to recreate the environment in which the original data package 15 was generated. Additionally, the “metadata” may contain validation data (e.g. a checksum type parameter) to ensure that any regenerated data package is a valid, accurate copy of the original data package 15. If data packages 15 are deleted, the “metadata” relating to these data packages may be retained.

“Metadata” may solely comprise information relating to individual data packages 15. Optionally, the data packages 15 could be stored in more than one domain and the “metadata” may comprise information relating to the entire domain.

FIG. 3 illustrates a flow chart of a method of data curation embodying the invention. As shown in the Figure and described above, in a first step 205 a user (e.g. management 140) defines one or more “global” variables (conditions) by which each data set can be assessed. In a second step 210 an optimiser 40 is used to select which data packages 15 are to be retained and which are to be removed from the data store 10 based on the “global” variables (conditions) defined by the user. In this example, a single “optimal solution” is automatically selected from those determined by the optimiser. The next step 215 therefore checks whether the data packages flagged with a “delete” state by the optimiser ought to be deleted automatically 220 (e.g. where the data is low risk) or whether authorisation from a user should be sought 225. In the latter case, if the user is satisfied with the results of the “optimisation” the data packages are deleted 230. If, however, the user is dissatisfied with the results of the “optimisation” an alternative “optimal solution” can be presented to the user 235 by redefining the hierarchy of the “global” variables (conditions) or the user can return to the first step 205 and completely redefine some or all of the “global” variables (conditions) for the data.

It is to be appreciated that the above described method is particularly suited to managing the output files from a series of computational simulations relating to a particular project. Whilst in the following embodiment of the invention computational fluid dynamics (CFD) simulations are considered, it is to be understood that the method is equally applicable to output files or “data packages” resulting from any type of simulation.

In this embodiment, the series of CFD simulations results in one hundred different data packages each from a different simulation. Three types of simulations are carried out of varying complexity. The size of data packages for the different simulations reflects the complexity of the simulation. Panel code simulations are the least sophisticated, are quick to perform and result in small data packages of approximately 1 MB each. The Euler code simulations are more sophisticated, take longer to set up the simulation, longer to perform the simulation and result in larger data packages of approximately 10 MB each. The Navier-Stokes (N-S) code simulations are the most sophisticated having an improved level of accuracy due to the complex code and the increase level of input parameters needed. The N-S simulations take much longer to set up the simulation, take much longer to perform the simulation and result in much larger data packages of approximately 100 MB each.

An importance factor (1→5, 5 being of greater importance) is allocated to each of the data packages as represented in the following table. The numbers represent the number of data packages having the particular importance factor allocated thereto.

| | | | | | | Total # |
|---|---|---|---|---|---|---|
| Importance rating | 1 | 2 | 3 | 4 | 5 | simulations |
| Panel Code | 30 | 20 | 5 | 4 | 1 | 60 |
| Euler Code | 10 | 5 | 5 | 6 | 4 | 30 |
| N-S Code | 0 | 0 | 5 | 2 | 3 | 10 |
| | | | | | Total | 100 |

The “global” variables (conditions) considered in this embodiment are:—
1. Cumulative magnitude of the retained data packages is constrained to 750 MB.
2. Cumulative time to regenerate the deleted data packages must be minimised.
3. Cumulative importance factor for the deleted data packages must be minimised.

The cumulative magnitude of the 100 data packages exceeds 1 GB and so the first “global” variable (condition) is not met and data curation resulting in some deletion of data packages 15 must be carried out. FIG. 4 illustrates the result of the “optimisation”. Any data set whereby the cumulative magnitude of the data packages having a “retain” state exceeds 750 MB is not plotted on the graph. For each remaining data set, the data packages having a “delete” state allocated thereto are evaluated. The cumulative value of importance factor “to be deleted” is plotted against the cumulative time to regenerate each data package “to be deleted” for each data set. As each of these “global” variables (conditions) are to be minimised, the “optimal solutions” are represented in the bottom left hand corner of the graph. These solutions represent a Pareto frontier and any solution lying on this frontier is called a Pareto “optimal solution”.

Three such potential solutions are highlighted in this example:

| | time to regenerate | cumulative importance factor |
|---|---|---|
| Solution | “deleted” data packages | for “deleted” data packages |
| I | 6870 minutes | 119 |
| II | 7710 minutes | 86 |
| III | 7762 minutes | 79 |

Any one of these solutions could be selected as the preferred data set by a user. If automatic selection were to be carried out then a hierarchy for the “global” variables (conditions) must be defined. If the third “global” variable (minimising the “deleted” importance factor) were to rank highest then “optimal solution” III would be automatically selected. If, however, the second “global” variable above described (minimising regeneration time of deleted data) were to rank highest then solution I would be automatically selected.

In practice, the above described method is implemented through a number of modules as illustrated in FIG. 5. As shown in the Figure, the problem definition module 305 is used by management 140 to define one or more “global” variables (conditions) and one or more system constraints. The query module 310 is used by the data agent 20 to monitor and interrogate the data packages 15 in relation to the system constraints. The optimisation module 315 performs the “optimisation” using optimiser 40 upon instruction from the data agent 20 either a) as required in response to the monitoring activities, b) as required according to a predetermined schedule or c) as required due to an overriding instruction received through the data manager 30 from management 140. The authorisation module 320 is initiated by the data manager 30 to determine, upon input from the management 140, whether the “optimal solution” should be invoked [optional module].

The action module 325 is implemented by the data manager 30 and the data agent 20 to perform the actions proposed by the “optimal solution”. These actions include, for example, “retain”, “delete”, “compress” and “archive”.

It is to be understood that a wide selection of storage devices, for example computer hard disks, computer floppy disks, CDs and DVDs could be used in this invention.

It is to be understood that any feature described in relation to any one embodiment may be used alone, or in combination with other features described, and may also be used in combination with one or more features of any other of the embodiments, or any combination of any other of the embodiments. Further, equivalents and modifications not described above may also be employed without departing from the scope of the invention, which is defined in the accompanying claims.

1. A method of data curation comprising the steps of:
(i) identifying a first set of variables which represent predetermined characteristics of data stored in one or more of a number of data packages;
(ii) identifying a second set of variables which represent different possible states of each said number of data packages;
(iii) identifying a functional relationship between the first and second sets of variables so as to provide a functional representation based on said sets of variables;
(iv) allocating different states to the data associated with each said number of data packages according to an iterative procedure, wherein the iterative procedure comprises iteratively calculating values of said variables and of the functional representation until the values satisfy predetermined convergence criteria, and the allocation of a state to one or more of the data packages is effected in dependence upon a comparison of the calculated values of said variables and of the functional representation; and
(v) performing an action on the data associated with each said number of data packages corresponding to the allocation of states in step (iv).

2. A method as claimed in claim 1, comprising processing one or more of the data packages on rewritable storage where a first state allocated to the data is an intention to delete the data package(s) from the storage while taking no further action and a second state allocated to the data is an intention to retain the data package(s) on the storage.

3. A method as claimed in claim 2, wherein another state allocated to the data is an intention to create a copy of said one or more data packages on different storage.

4. A method as claimed in claim 2, wherein another state allocated to the data is an intention to create a compressed version of said one or more data packages on the same or different storage.

5. A method as claimed in claim 1, wherein the functional representation is of the form:
F=f(t,cₛ),
F being defined as a function of (i) the original time t taken to generate the data, and (ii) the cost cₛ of the software required to regenerate the data.

6. A method as claimed in claim 1, wherein the convergence criteria used in the iterative procedure are applied by calculating a change in the value of the functional representation between two or more successive iterations of values of said representation and determining whether said calculated change in the value is substantially equal to a specified tolerance.

7. A method as claimed in claim 1, wherein the second set of variables correspond to a set of independent variables, and the first set of variables correspond to a set of dependent variables which are dependent on the second set of variables.

8. A method as claimed in claim 1, further including summing the values of the first set of variables which represent different characteristics of the data stored in said one or more data package(s) and selecting the data according to the sum values on which action is to be performed.

9. A method as claimed in claim 1, further comprising:
(a) a first step of selectively presenting the data to a user;
(b) a second step of requesting authorisation from the user to perform an action on the data; and
(c) a third step of performing the action only subject to grant of the authorisation request.

10. A method as claimed in claim 9, further including a step of repeating the aforesaid steps (i) to (iv) in a series of time steps as an iterative procedure such as to enable a recalculation of the values of said variables, in the event that the authorisation request is refused.

11. A method as claimed in claim 1, wherein the data packages are digital data packages.

12. A method as claimed in claim 11, wherein the digital data packages are binary data packages.

13. (canceled)

14. A computer program comprising program code means for performing the method steps as claimed in claim 1 when the program is run on a computer.

15. A computer program product comprising program code means stored on a computer readable medium for performing the method steps as claimed in claim 1 when the program is run on a computer.

16. A data processing apparatus arranged to perform the method as claimed in claim 1.

17. A method as claimed in claim 3, wherein another state allocated to the data is an intention to create a compressed version of said one or more data packages on the same or different storage.

18. A method as claimed in claim 2, wherein the functional representation is of the form:
F=f(t,cₛ),
F being defined as a function of (i) the original time t taken to generate the data, and (ii) the cost cₛ of the software required to regenerate the data.

19. A method as claimed in claim 3, wherein the convergence criteria used in the iterative procedure are applied by calculating a change in the value of the functional representation between two or more successive iterations of values of said representation and determining whether said calculated change in the value is substantially equal to a specified tolerance.

20. A method as claimed in claim 4, wherein the second set of variables correspond to a set of independent variables, and the first set of variables correspond to a set of dependent variables which are dependent on the second set of variables.

21. A method as claimed in claim 7, further including summing the values of the first set of variables which represent different characteristics of the data stored in said one or more data package(s) and selecting the data according to the sum values on which action is to be performed.
